(19) United States
(12) Patent Application Publication
(10) Pub. No.: US 2018/0016824 A1
(43) Pub. Date: Jan. 18, 2018

(54) QUICK RELEASE DOOR LOCKING DEVICE AND METHOD OF USE

(71) Applicant: Jason Todd Durrant, Red Deer County (CA)

(72) Inventor: Jason Todd Durrant, Red Deer County (CA)

(21) Appl. No.: 15/212,182

(22) Filed: Jul. 15, 2016

(51) Int. Cl. E05C 19/12

(52) U.S. Cl. CPC E05C 19/12

(57) ABSTRACT

A quick release door locking device, comprising: a) a door frame comprising a strike plate, wherein the strike plate comprising a door latch hole aligned with a corresponding door frame hole for receiving a door latch of the door lock when the door is closed; b) a door comprising a door latch capable of engaging with the door latch hole and door frame hole; and c) a door latch cover plate comprising a first side, a second side, a upper end, a lower end, a left side, a right side and a cover plate gate, wherein the cover plate comprises a pivot aperture at a position adjacent to the upper end, wherein the pivot aperture comprises a first cover plate fastener therethrough and pivotally affixed to the door in an adjacent position above the door latch.

### FIELD OF THE INVENTION

The present disclosure is in the field of door security devices and in particular, door security devices designed for commercial building and educational institutions.

### BACKGROUND OF THE DISCLOSURE

Unfortunately, educational institutions and commercial building lockdowns occur too often. In these situations, teachers, students, employees, etc. often must resort to taking protective cover in a room with a lockable door. The individual seeking cover within an office, classroom or otherwise would need to engage a door key outside the room and into the hallway in order to lock the door from the outside. This places the individual at risk and takes critical time to open the door and engage the key with the door lock from outside the room.

Therefore, there is a need for a quick release door locking device, whereby an adult or child may quickly lock the door without fully opening the door and by merely exposing the door latch, thereby eliminating the time it takes to find the door key, open the door, lock the door from the outside and step back into the classroom.

### SUMMARY OF THE INVENTION

Disclosed herein is a quick release door locking device, comprising: a) a door frame comprising a strike plate, wherein the strike plate comprising a door latch hole aligned with a corresponding door frame hole for receiving a door latch of the door lock when the door is closed; b) a door comprising a door latch capable of engaging with the door latch hole and door frame hole; and c) a door latch cover plate comprising a first side, a second side, a upper end, a lower end, a left side, a right side and a cover plate gate, wherein the cover plate comprises a pivot aperture at a position adjacent to the upper end, wherein the pivot aperture comprises a first cover plate fastener therethrough and pivotally affixed to the door in an adjacent position above the door latch, wherein a second cover plate fastener is affixed to the door in an adjacent position below the door latch, and wherein the cover plate gate is capable of engaging the second cover plate fastener or second cover plate post and preventing the door latch from engaging with the door latch hole and door frame hole.

### BRIEF DESCRIPTION OF THE DRAWINGS

FIG. 1 is an illustration of a quick release door locking device 100 whereby a cover plate 102 is depicted in an angled uncovered position relative to the door latch 114.

FIG. 2 is an illustration of a quick release door locking device 200 whereby a cover plate 102 is depicted in a parallel covered position relative to the door latch 114.

FIG. 3 is an illustration of the quick release door locking device 100 in an angled uncovered position whereby the door latch 114 is engaged with a door strike hole 602 and door frame hole 604.

FIG. 4 is an illustration of a cover plate 300 with a first side 136, a second side 134 and a cover plate gate 104.

FIG. 5A is an illustration a partial view of a cover plate 102 comprising a pivot aperture 132 and a first cover plate fastener 108 therethrough and pivotally affixed to the door 112 above the door latch 114.

FIG. 5B is an illustration of a partial view of a cover plate 102 comprising a second cover plate fastener 110 is affixed to the door 112 in an adjacent position below the door latch 114.

FIG. 6 is an illustration of a jig door cover plate drill system 400 comprising a jig 402 that comprises a jig door latch channel 420, and one or more jig holes 414 and 416 positioned above and below the jig door latch channel 420.

### DETAILED DESCRIPTION OF THE EMBODIMENTS

The following is a detailed description of certain specific embodiments of the quick release door locking device, quick release door locking device kit and methods of use disclosed herein.

In one aspect, disclosed herein is a quick release door locking device, comprising: a) a door frame comprising a strike plate, wherein the strike plate comprising a door latch hole aligned with a corresponding door frame hole for receiving a door latch of the door lock when the door is closed; b) a door comprising a door latch capable of engaging with the door latch hole and door frame hole; and c) a door latch cover plate comprising a first side, a second side, a upper end, a lower end, a left side, a right side and a cover plate gate, wherein the cover plate comprises a pivot aperture at a position adjacent to the upper end, wherein the pivot aperture comprises a first cover plate fastener therethrough and pivotally affixed to the door in an adjacent position above the door latch, wherein a second cover plate fastener is affixed to the door in an adjacent position below the door latch, wherein the cover plate gate is capable of engaging the second cover plate fastener or second cover plate post and preventing the door latch from engaging with the door latch hole and door frame hole, and wherein the cover plate comprises a rectangular shape and rounded corners.

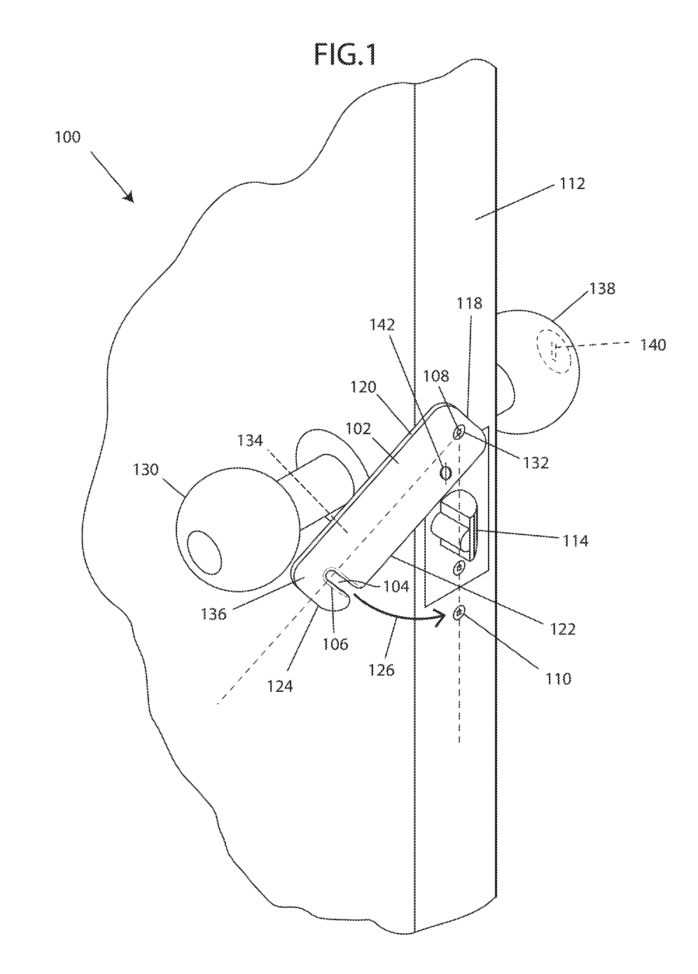

Turning to the drawings, FIG. 1 is a depiction of a quick release door locking device 100 in an angled uncovered position relative to the door latch 114. As illustrated, the cover plate 102 is at an angled uncovered position whereby the door latch 114 is in an extended position and capable of engaging with a door latch hole and door frame hole. The quick release door locking device 100 comprises a cover plate 102 comprising a first side 136, a second side 134, a upper end 118, a lower end 124, a left side 120, a right side 122 and a cover plate gate 104. The cover plate 102 comprises a pivot aperture 132 at a position adjacent to the upper end 118 whereby the cover plate is pivotally affixed to the door face 112 via a first cover plate fastener 108. In the angled uncovered position of FIG. 1, the cover plate 102 is positioned at an angle 142 relative to the door latch 114 of between about 1 degree and 90 degrees. In some embodiments, the cover plate is pivotable about the first cover plate fastener of the pivot aperture between a parallel covered position and an angled uncovered position. In some embodiments, the cover plate 102 is positioned at an angle 142 relative to the door latch 114 of between about 1 degree and 45 degrees. As depicted with FIG. 1, the cover plate gate 104 is tapered gate edge 106 that is tapered away from the first side 136 towards the second side 134, thereby affording a tapered edge that is capable of engaging a second cover plate fastener 110. In some embodiments, the first cover plate fastener and/or the second cover plate fastener comprise a frusta-conical head portion.

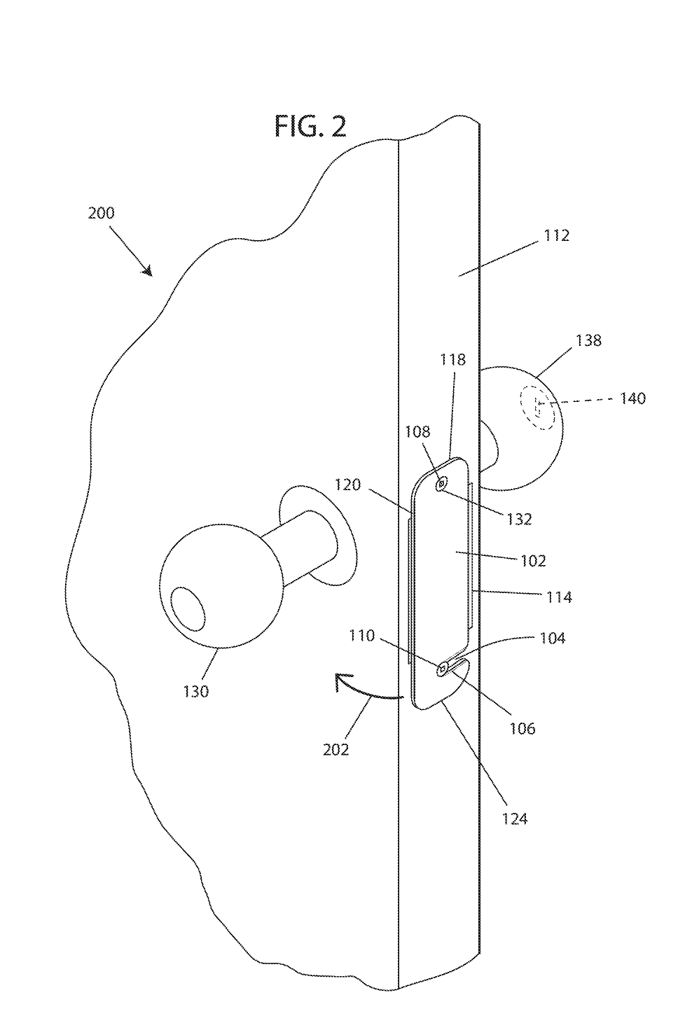

FIG. 2 depicts a quick release door locking device 200 whereby a cover plate 102 is depicted in a parallel covered position relative to the door latch 114. In some embodiments, wherein the cover plate is positioned over the door latch, and wherein the second side of the cover plate faces the door latch. In operation, the inside door handle 130 is twisted to move the door latch 114 to about flush with the door face 112 and then the cover plate 102 is moved in direction 126 by a user to engage the cover plate gate 104 with the second cover plate fastener 110 and the door handle 130 is released and the door is closed with the door having been previously locked with an outside door handle 138 via a key lock aperture 140. As depicted with FIG. 2, the cover plate gate 104 is engaged with the second cover plate fastener 110 and the latch is held in place behind the cover plate and resting against the second side 134 of the cover plate and is thereby prevented from engaging with a door strike hole 602 and a door frame hole 604. During a lockdown or otherwise with the door having been previously locked with an outside door handle 138 a user operates the quick release door locking device 200 from the parallel covered position of FIG. 2 by opening the door slightly to expose the cover plate 102, whereby the user moves the cover plate 102 in direction 202 to the angled uncovered position of FIG. 1, which releases the lock door latch 114 and the door is closed which engages the locked door latch 114 with the door strike hole 602 and the door frame hole 604. At this stage, the door is locked without the user being required to go outside the room to lock the door with a key into a hallway or otherwise. Moreover, since the cover plate 102 only must be exposed or partially exposed to move the cover plate 102 in direction 202 at an angle of between about 1 degree and 45 degrees, which saves valuable seconds in a building lockdown. Moreover, the cover plate 102 may be accessed by an adult or child in a lockdown situation.

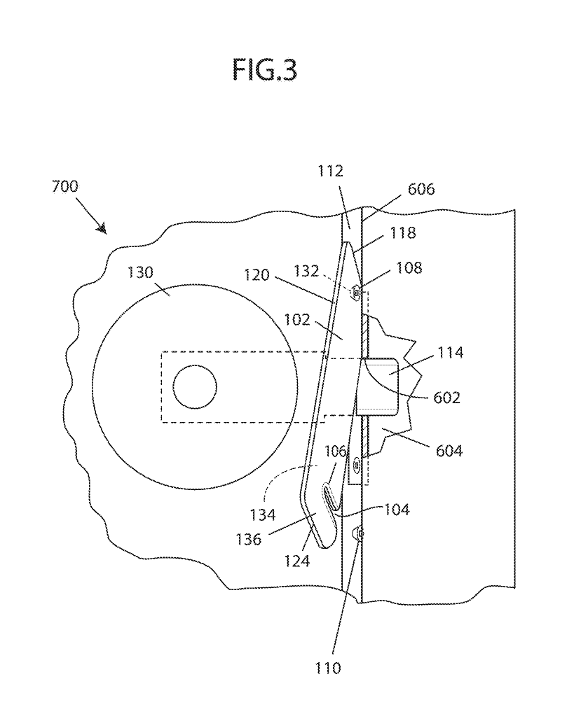

As illustrated, FIG. 3 depicts the quick release door locking device 100 in an angled uncovered position, whereby the door latch 114 is engaged with a door strike hole 602 and door frame hole 604 affixed on a door frame 606 and the door is closed while being locked with an outside door handle 138. In some embodiments, the cover plate is pivotable about the first cover plate fastener of the pivot aperture between a parallel covered position and an angled uncovered position, wherein the angled uncovered position allows for the door latch to engage with the door latch hole and door frame hole.

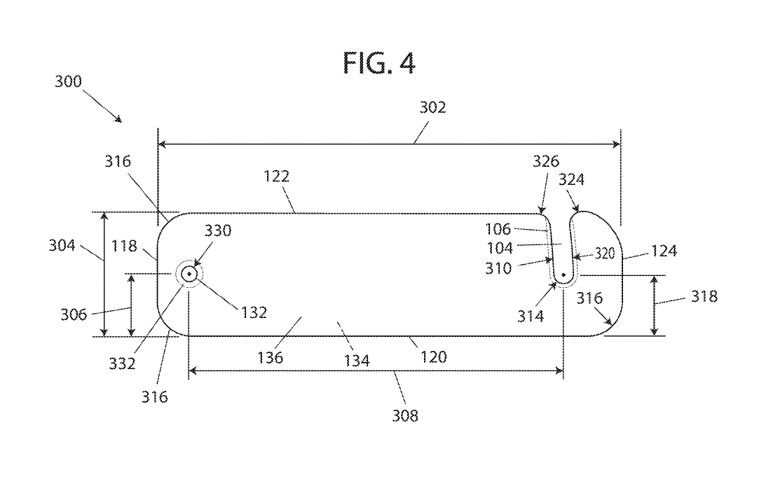

Turning to FIG. 4, the cover plate 300 is depicted as right door opening version whereby as illustrated with FIGS. 1-3, the door latch is on the right side of the door from the inside door handle 130. It will be apparent that a cover plate as a left door opening version would be a mirror image of the first side 136 of the right door opening version of FIGS. 1, 2, 3, 4, 5A and 5B, with respect to the tapered gate edge 106 and the pivot aperture 132 recessed portion 332 or other features of each side of the cover plate. The cover plate 300 comprises a first side 136, a second side 134, a upper end 118, a lower end 124, a left side 120, a right side 122 and a cover plate gate 104. In some embodiments, the left side and the right side comprise a pair of substantially parallel sides extending between the upper end and the lower end. In some embodiments, the first side and second side of the cover plate each comprise a rectangular planar surface. In some embodiments, the left side and the right side comprise a pair of substantially parallel sides extending between the upper end and the lower end. Moreover, the cover plate 300 comprises pivot aperture 132 with a diameter 330 and the pivot aperture 132 is recessed 332 and tapering away from the first side 136 towards the second side 134 of the cover plate 300. In some embodiments, the pivot aperture 132 is positioned at a distance 306 from the left side 120 of between about 6.35 mm (¼ inch) and 25.40 mm (1 inch) and at a distance from the upper end 118 of between about 6.35 mm (¼ inch) and 25.40 mm (1 inch). In some embodiments, the cover plate 300 has a width 304 of between about 19.05 mm (¾ inches) and 38.10 mm (1.5 inches). In some embodiments, the cover plate 300 has a width 304 of about 25.40 mm (1 inch). The cover plate gate 104 has a diameter 314 of between about 2.54 mm (0.1 inches) and 25.40 mm (1 inch). In some embodiments, the cover plate gate 104 has a diameter 314 of between about 2.54 mm (0.1 inches) and 25.40 mm (1 inch), whereby the center of the diameter 314 is a distance 308 of about 76.987 mm (3.031 inches) from the center of the diameter 330 of the pivot aperture 132 and at a distance 318 about 12.70 mm (0.5 inches) from the left side 120. In some embodiments, the cover plate gate 104 has a diameter 314 of about 4.77 mm (0.188 inches), whereby the center of the diameter 314 is about 76.987 mm (3.031 inches) from the center of the diameter 330 of the pivot aperture 132 and about 12.70 mm (0.5 inches) from the left side 120. As illustrated, the pivot aperture 132 is centered at about 12.70 mm (0.5 inches) from the left side 120 and 12.70 mm (0.5 inches) from the upper end 118. In some embodiments, the pivot aperture 132 is centered between about 6.35 mm (¼ inch) and 25.40 mm (1 inch) from the left side 120 and between about 6.35 mm (¼ inch) and 50.80 mm (2 inches) from the upper end 118. The cover plate 300 also may comprise rounded corners 326 and 324 at the opening of the cover plate gate 104. Moreover, the additional rounded corners for the cover plate may be incorporated such as rounded corner 316. In some embodiments, the cover plate gate 104 is tapered gate edge 106 that is tapered away from the first side 136 towards the second side 134, thereby affording a tapered edge capable of engaging a second cover plate fastener 110. In some embodiments, the tapered gate edge 106 comprises an upper end edge with a radius 310 and a lower end edge with a radius 320, whereby the radius is derived from the center of the diameter 330 of the pivot aperture 132. In some embodiments, the cover plate 300 has a length 302 of between about 63.50 mm (2.5 inches) and 157.20 mm (18 inches). In some embodiments, the cover plate gate has a gate edge of the first side of the cover plate that tapers away from the first side of the cover plate. In some embodiments, the cover plate gate has a gate diameter of between about 1.587 mm (0.0625 inches) and 25.40 mm (1 inch). In some embodiments, the cover plate gate has a gate radius of between about 63.50 mm (2.5 inches) and 157.20 mm (18 inches). In some embodiments, the cover plate 102 is fabricated from steel, aluminum, aluminum alloy, tin, carbon fiber, plastic, stainless steel or a combination thereof. The thickness of the cover plate 102 is thin enough to permit closing of the door uninhibited by the cover plate. In some embodiments, the cover plate 102 may have a thickness defined between the faces of the cover plate of between about 0.5 mm (0.02 inches) and 2.54 mm (0.1 inch). In some embodiments, the cover plate 102 is comprised of 18 gauge stainless steel.

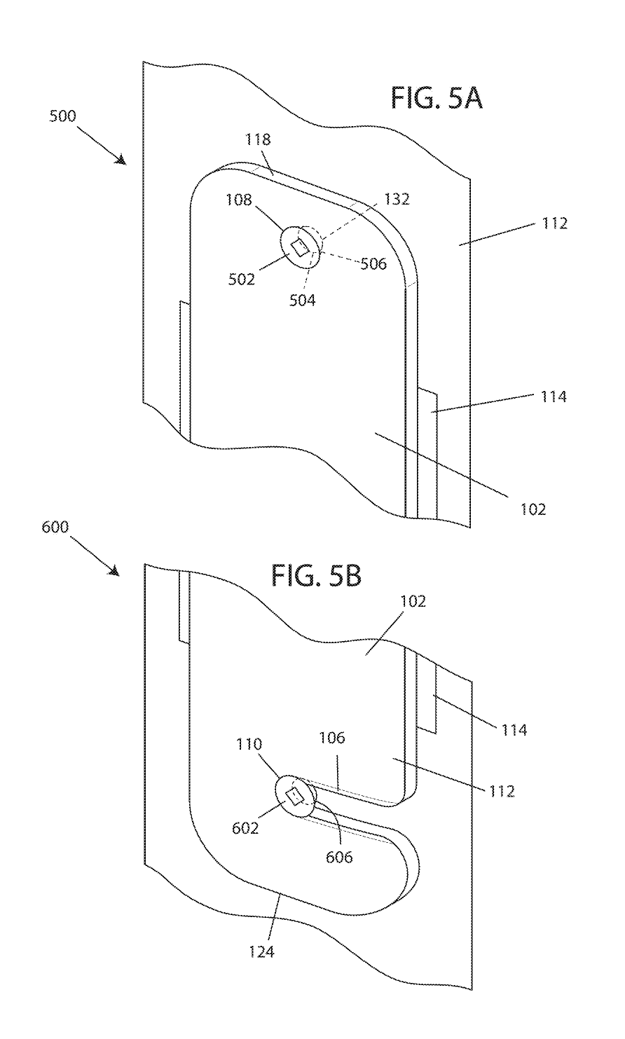

As discussed, the cover plate 102 comprises a pivot aperture 132 at a position adjacent to the upper end 118 whereby the cover plate is pivotally affixed to the door face 112. FIG. 5A depicts a partial view of the cover plate 102 comprising a pivot aperture 132 and a first cover plate fastener 108 therethrough and pivotally affixed to the door 112 above the door latch 114. The first cover plate fastener 108 may be conically shaped 506 to be countersunk in a recessed 504 pivot aperture, whereby the head 502 of the first cover plate fastener 108 is flush with the first side 136 of the cover plate 102. In some embodiments, the pivot aperture is recessed and tapering away from the first side towards the second side of the cover plate, wherein the recess is adapted for receiving therein a head portion of the first fastener, wherein the head portion of the fastener is flush relative to a plane of the first side of the cover plate, and wherein the cover plate is pivotally affixed to the door.

Turning to the lower end 124 of the cover plate 102, FIG. 5B depicts a partial view of a cover plate 102 comprising a second cover plate fastener 110 that is affixed to the door 112 in an adjacent position below the door latch 114. In this illustration, the cover plate in the parallel covered position of FIG. 2, whereby the second cover plate fastener 110 is engaged with the cover plate gate 104. In some embodiments, the second cover plate fastener is a threaded screw, metal post or metal pin. In some embodiments, the tapered gate edge 106 engages with the second cover plate fastener 110, whereby the head 602 may be conically shaped 606 to mate with the tapered gate edge 106 and thereby holding the cover plate 102 in the parallel covered position with the pressure from the door latch against the second side 134 of the cover plate 102. Moreover, the head 602 is flush with the planar surface of the first side 136 of the cover plate 102. In some embodiments, the cover plate gate has a gate edge of the first side of the cover plate that tapers away from the first side of the cover plate, wherein the second cover plate fastener comprises a frusta-conical head portion, and wherein the second cover plate fastener's frusta-conical head portion is capable of engaging with the gate edge of the cover plate gate. In some embodiments, the first cover plate fastener and/or the second cover plate fastener comprise a head portion capable of engaging a tool for rotating each threaded fastener.

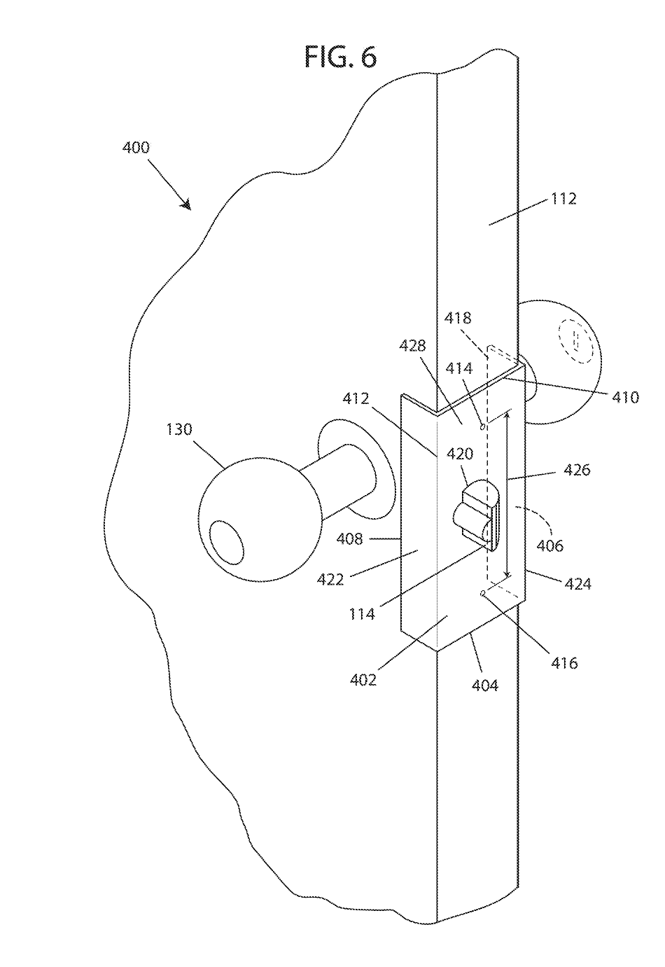

FIG. 6 is an illustration of a jig door cover plate drill system 400 comprising a jig 402 that comprises a jig door latch channel 420, and one or more jig holes 414 and 416 positioned above and below the jig door latch channel 420. In some embodiments, there are two jig holes 414 and 416 positioned in-line and centered with the door latch 114 via the jig door latch channel 420 and spaced at a distance 426. In some embodiments, the distance 426 is between about 63.50 mm (2.5 inches) and 157.20 mm (18 inches). In some embodiments, the distance 426 is about 76.987 mm (3.031 inches). The two jig holes 414 and 416 are used as pilot holes to drill holes in the door 112 capable of engaging with the first cover plate fastener 108 and the second cover plate fastener 110. In some embodiments, the jig 402 comprises a door latch face 428, a left side 422, a right side 406, a left edge 408, a right edge 418, a left corner bend 412, a right corner bend 424, a lower edge 404 and an upper edge 410. In some embodiments, the jig 402 is sized and shaped to accommodate the door latch door face 112. In some embodiments, the jig 402 comprises the two jig holes 414 and 416, the jig door latch channel 420 and the door latch face 428. The jig door latch channel 420 is interposed between the jig holes 414 and 416 of the jig 402.

In another aspect disclosed herein is a method of locking a door, comprising: a) positioning a quick release door locking device in a parallel covered position, comprising: i) a door frame comprising a strike plate, wherein the strike plate comprising a door latch hole aligned with a corresponding door frame hole for receiving a door latch of the door lock when the door is closed, ii) a door comprising a door latch capable of engaging with the door latch hole and door frame hole, and iii) a door latch cover plate comprising a first side, a second side, a upper end, a lower end, a left side, a right side and a cover plate gate, wherein the cover plate comprises a pivot aperture at a position adjacent to the upper end, wherein the pivot aperture comprises a first cover plate fastener therethrough and pivotally affixed to the door in an adjacent position above the door latch, wherein a second cover plate fastener is affixed to the door in an adjacent position below the door latch, and wherein the cover plate gate is capable of engaging the second cover plate fastener or second cover plate post and preventing the door latch from engaging with the door latch hole and door frame hole; b) locking the door latch; c) opening door to expose the cover plate; d) positioning the cover plate from the parallel covered position to an angled uncovered position; and e) closing the door to engage door latch with the door latch hole and door frame hole thereby locking the door.

In yet another aspect disclosed herein is a kit, comprising: a) quick release door locking device, comprising: i) a door frame comprising a strike plate, wherein the strike plate comprising a door latch hole aligned with a corresponding door frame hole for receiving a door latch of the door lock when the door is closed, ii) a door comprising a door latch capable of engaging with the door latch hole and door frame hole, and iii) a door latch cover plate comprising a first side, a second side, a upper end, a lower end, a left side, a right side and a cover plate gate, wherein the cover plate comprises a pivot aperture at a position adjacent to the upper end, wherein the pivot aperture comprises a first cover plate fastener therethrough and pivotally affixed to the door in an adjacent position above the door latch, wherein a second cover plate fastener is affixed to the door in an adjacent position below the door latch, and wherein the cover plate gate is capable of engaging the second cover plate fastener or second cover plate post and preventing the door latch from engaging with the door latch hole and door frame hole; and b) a jig comprising; i) a jig door latch channel, and ii) one or more jig holes positioned above and below the jig door latch channel, wherein the one or more jig holes are used to drill holes above and below the door latch capable of engaging the cove plate fasteners.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict any definitions in this disclosure.

What is claimed is:

1. A quick release door locking device, comprising:
a) a door frame comprising a strike plate, wherein the strike plate comprising a door latch hole aligned with a corresponding door frame hole for receiving a door latch of the door lock when the door is closed;
b) a door comprising a door latch capable of engaging with the door latch hole and door frame hole; and
c) a door latch cover plate comprising a first side, a second side, a upper end, a lower end, a left side, a right side and a cover plate gate, wherein the cover plate comprises a pivot aperture at a position adjacent to the upper end, wherein the pivot aperture comprises a first cover plate fastener therethrough and pivotally affixed to the door in an adjacent position above the door latch, wherein a second cover plate fastener is affixed to the door in an adjacent position below the door latch, and wherein the cover plate gate is capable of engaging the second cover plate fastener or second cover plate post and preventing the door latch from engaging with the door latch hole and door frame hole.

2. The quick release door locking device of claim 1, further comprising that the cover plate comprises a rectangular shape and rounded corners.

3. The quick release door locking device of claim 1, wherein the pivot aperture is recessed and tapering away from the first side towards the second side of the cover plate, wherein the recess is adapted for receiving therein a head portion of the first fastener, wherein the head portion of the fastener is flush relative to a plane of the first side of the cover plate, and wherein the cover plate is pivotally affixed to the door.

4. The quick release door locking device of claim 1, wherein the cover plate gate has a gate edge of the first side of the cover plate that tapers away from the first side of the cover plate.

5. The quick release door locking device of claim 1, wherein the cover plate gate has a gate diameter of between about 1.587 mm (0.0625 inches) and 25.40 mm (1 inch).

6. The quick release door locking device of claim 1, wherein the cover plate gate has a gate radius of between about 63.50 mm (2.5 inches) and 157.20 mm (18 inches).

7. The quick release door locking device of claim 1, wherein the first cover plate fastener and/or the second cover plate fastener comprise a frusta-conical head portion.

8. The quick release door locking device of claim 1, wherein the second cover plate fastener is a threaded screw, metal post or metal pin.

9. The quick release door locking device of claim 1, wherein the cover plate gate has a gate edge of the first side of the cover plate that tapers away from the first side of the cover plate, wherein the second cover plate fastener comprises a frusta-conical head portion, and wherein the second cover plate fastener's frusta-conical head portion is capable of engaging with the gate edge of the cover plate gate.

10. The quick release door locking device of claim 1, wherein the first cover plate fastener and/or the second cover plate fastener comprise a head portion capable of engaging a tool for rotating each threaded fastener.

11. The quick release door locking device of claim 1, wherein the first side and second side of the cover plate each comprise a rectangular planar surface.

12. The quick release door locking device of claim 1, wherein the left side and the right side comprise a pair of substantially parallel sides extending between the upper end and the lower end.

13. The quick release door locking device of claim 1, wherein the cover plate is positioned over the door latch, and wherein the second side of the cover plate faces the door latch.

14. The quick release door locking device of claim 1, wherein the cover plate is pivotable about the first cover plate fastener of the pivot aperture between a parallel covered position and an angled uncovered position.

15. The quick release door locking device of claim 1, wherein the cover plate is pivotable about the first cover plate fastener of the pivot aperture between a parallel covered position and an angled uncovered position, wherein the angled uncovered position allows for the door latch to engage with the door latch hole and door frame hole.

16. A method of locking a door, comprising:
a) positioning a quick release door locking device in a parallel covered position, comprising:
i. a door frame comprising a strike plate, wherein the strike plate comprising a door latch hole aligned with a corresponding door frame hole for receiving a door latch of the door lock when the door is closed,
ii. a door comprising a door latch capable of engaging with the door latch hole and door frame hole, and
iii. a door latch cover plate comprising a first side, a second side, a upper end, a lower end, a left side, a right side and a cover plate gate, wherein the cover plate comprises a pivot aperture at a position adjacent to the upper end, wherein the pivot aperture comprises a first cover plate fastener therethrough and pivotally affixed to the door in an adjacent position above the door latch, wherein a second cover plate fastener is affixed to the door in an adjacent position below the door latch, and wherein the cover plate gate is capable of engaging the second cover plate fastener or second cover plate post and preventing the door latch from engaging with the door latch hole and door frame hole;
b) locking the door latch;
c) opening door to expose the cover plate;
d) positioning the cover plate from the parallel covered position to an angled uncovered position; and
e) closing the door to engage door latch with the door latch hole and door frame hole thereby locking the door.

17. A kit, comprising:
a) quick release door locking device, comprising:
i. a door frame comprising a strike plate, wherein the strike plate comprising a door latch hole aligned with a corresponding door frame hole for receiving a door latch of the door lock when the door is closed,
ii. a door comprising a door latch capable of engaging with the door latch hole and door frame hole, and
iii. a door latch cover plate comprising a first side, a second side, a upper end, a lower end, a left side, a right side and a cover plate gate, wherein the cover plate comprises a pivot aperture at a position adjacent to the upper end, wherein the pivot aperture comprises a first cover plate fastener therethrough and pivotally affixed to the door in an adjacent position above the door latch, wherein a second cover plate fastener is affixed to the door in an adjacent position below the door latch, and wherein the cover plate gate is capable of engaging the second cover plate fastener or second cover plate post and preventing the door latch from engaging with the door latch hole and door frame hole; and
b) a jig comprising:
i. a jig door latch channel, and
ii. one or more jig holes positioned above and below the jig door latch channel,
wherein the one or more jig holes are used to drill holes above and below the door latch capable of engaging the cove plate fasteners.
